(19) United States
(12) Patent Application Publication
(10) Pub. No.: US 2004/0109647 A1
(43) Pub. Date: Jun. 10, 2004

(54) Impact mounted bundled optical fiber devices

(76) Inventors: Michel Y. Rondeau, Reno, NY (US); Shin-Lo Chia, Fremont, CA (US); Israel M. Miranda, San Jose, CA (US); Alpha F. Diallo, Davis, CA (US)

Correspondence Address: INTELLECTUAL PROPERTY LAW OFFICE, 1901 S. BASCOM AVENUE, SUITE 660, CAMPBELL, CA, 95008, US

(21) Appl. No.: 10/313,977

(22) Filed: Dec. 6, 2002

(51) Int. Cl. G02B 6/36

(52) U.S. Cl. 385/81; 385/85

(57) ABSTRACT

An optical fiber device includes a plurality of optical fibers that are bundled together within an impact mounted ferrule. A preferred impact mounted bundled optical fiber device includes two, three, four, seven, thirteen or nineteen optical fibers. In these devices the optical fibers are fixedly held in place by frictional contact between the optical fibers within the impact mounted ferrule tip. The impact mounted bundled optical ferrule can be utilized in many optical devices including add/drop devices, bifurcation devices, signal combining devices, multiplexer devices, demultiplexer devices, isolator devices, as well as other types of optical signal processing devices.

### BACKGROUND OF THE INVENTION

1. Field of the Invention

The present invention relates generally to fiberoptic devices, and more particularly to fiberoptic devices having bundled optical fiber devices.

2. Description of the Prior Art

Fiberoptic devices that utilize bundled optical fibers, as opposed to single optical fibers, can be advantageous in saving valuable space within fiberoptic devices. Additionally, the number of components within a fiberoptic device can be reduced where, for instance, optical signals from multiple optical fibers in a bundle are directed through a single component, such as a lens or filter. Certain drawbacks exist, however, in the fabrication and usage of bundled optical fibers.

A significant problem that exists in the usage of bundled optical fiber devices is in the repeatable manufacturing of such bundled optical fiber devices, wherein the location of each of the optical fibers within the bundle needs to be symmetrical, fixed and can be repeatably manufactured from device to device. Where the location of the optical fibers within a bundle is not symmetrical and in a fixed location, the reliability of the device in transmitting optical signals is compromised, and as a result, such bundled optical fiber devices cannot be reliably manufactured and utilized. The present invention solves this problem by creating bundled optical fiber devices in which the location of each optical fiber within the bundle is fixed and repeatable in manufacturing, such that the reliability and usefulness of bundled optical fiber devices is greatly improved. The present invention utilizes an impact mounting device, such as is described in U.S. Pat. No. 5,305,406, to reliably and repeatably mount bundles of optical fibers within a ferrule.

### SUMMARY OF THE INVENTION

In the present invention, groups of optical fibers are disposed within a holder, such as a ferrule or connector, and the tip of the ferrule is deformed inwardly by an impact mounting device to symmetrically hold the bundled fibers together. Groups of optical fibers are preferably selected, in which each of the optical fibers is held in a fixed location by frictional contact with others of the optical fibers within the bundle, such that the optical fiber bundle is symmetrical and each of the optical fibers is disposed in a fixed orientation relative to the other optical fibers in the bundle. The impact mounted optical fiber bundles preferably are formed from groupings of optical fibers including two, three, four, seven, thirteen and nineteen optical fibers, which, when grouped together, will form symmetrical groupings in which each of the optical fibers is frictionally held in a fixed, repeatable orientation relative to the other optical fibers in the bundle. As a result, the impact mounted bundled optical fiber devices may be repeatably, accurately manufactured, and devices that utilize these impact mounted bundled optical fiber devices may be reliably created.

It is an advantage of the present invention that bundled optical fiber devices are created which may be repeatably manufactured.

It is another advantage of the present invention that a bundled group of optical fibers are impact mounted within a ferrule, such that each of the optical fibers is held in a known, repeatable, fixed orientation relative to other optical fibers in the bundle.

It is a further advantage of the present invention that optical fiber bundles are created in which the optical fibers are located in a fixed, symmetrical orientation relative to each of the other optical fibers in the bundle.

It is a further advantage of the present invention that bundled optical fiber devices are created having two, three, four, seven, thirteen and nineteen optical fibers therewithin.

These and other features and advantages of the present invention will no doubt become apparent to those skilled in the art upon reviewing the following detailed description which makes reference to the several figures of the drawings.

### IN THE DRAWINGS

FIG. 1A is a perspective view of the tip portion of a prior art impact mounted single optical fiber;

FIG. 1B is a front view of the tip of the impact mounted single optical fiber depicted in FIG. 1;

FIG. 2A is a perspective view of the tip portion of an impact mounted two optical fiber device;

FIG. 2B is a front view of the tip of the impact mounted device depicted in FIG. 2A;

FIG. 3A is a perspective view of the tip portion of an impact mounted three optical fiber device;

FIG. 3B is a front view of the tip of the impact mounted device depicted in FIG. 3A;

FIG. 4A is a perspective view of the tip portion of an impact mounted four optical fiber device;

FIG. 4B is a front view of the tip of the impact mounted device depicted in FIG. 4A;

FIG. 5B is a front view of the tip of an impact mounted five optical fiber device;

FIG. 6B is a front view of the tip of the impact mounted six optical fiber device;

FIG. 7A is a perspective view of the tip portion of an impact mounted seven optical fiber device;

FIG. 7B is a front view of the tip of the impact mounted device depicted in FIG. 7A;

FIG. 8 is a front view of the tip of an impact mounted thirteen optical fiber device;

FIG. 9 is a front view of the tip of an impact mounted nineteen optical fiber device;

FIG. 10 is a prior art add/drop device;

FIG. 11 is a schematic diagram of a prior art add/drop device such as is depicted in FIG. 10;

FIG. 12 is first add/drop device of the present invention utilizing an impact mounted two optical fiber device of the present invention;

FIG. 13 is an add/drop device of the present invention utilizing an impact mounted three optical fiber device of the present invention;

FIG. 14 is a schematic diagram of the add/drop device depicted in FIG. 13;

FIG. 15 is an add/drop device of the present invention utilizing an impact mounted four optical fiber device of the present invention;

FIG. 16 is a schematic diagram of the add/drop device depicted in FIG. 15.

FIG. 17 is an add/drop device of the present invention utilizing an impact mounted seven optical fiber device of the present invention;

FIG. 18 is a schematic diagram of the add/drop device depicted in FIG. 17.

FIG. 19 is a schematic diagram of an add/drop device of the present invention utilizing an impact mounted thirteen optical fiber device of the present invention;

FIG. 20 is a schematic diagram of an add/drop device of the present invention utilizing an impact mounted nineteen optical fiber device of the present invention;

FIG. 21 is a schematic diagram of a generalized architecture of an optical device utilizing the impact mounted optical fiber bundle of the present invention;

FIG. 22 is a schematic diagram depicting a second generalized optical device architecture of the present invention including an impact mounted bundled optical fiber device of the present invention;

FIG. 23 is a schematic diagram depicting an optical signal bifurcation or combination device of the present invention;

FIG. 24 is a schematic diagram depicting an optical signal multiplexer or demultiplexer device of the present invention;

FIG. 25 is a schematic diagram depicting a reflecting optical signal multiplexer or demultiplexer device of the present invention;

FIG. 26 is a schematic diagram depicting an optical signal isolator device of the present invention.

### DETAILED DESCRIPTION OF THE PREFERRED EMBODIMENTS

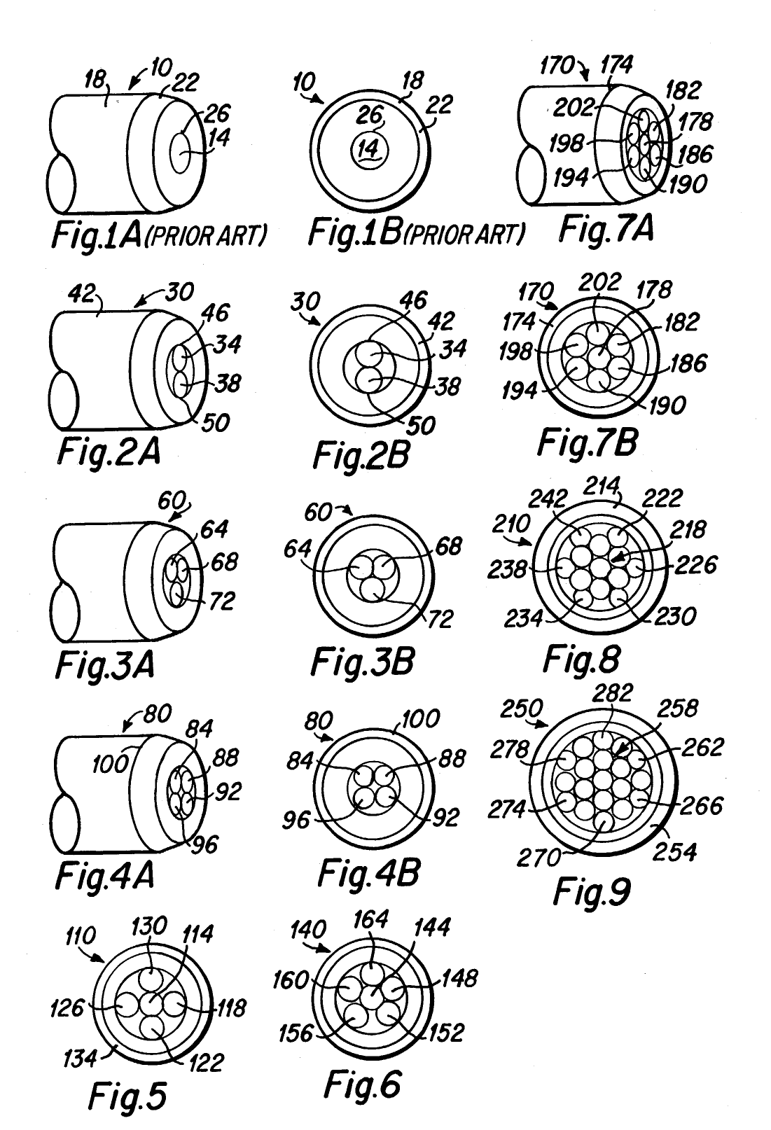

A prior art impact mounted single optical fiber 10 is depicted in FIG. 1 and serves as a reference point for the description of the present invention set forth below. As depicted in FIG. 1, an optical fiber 14 is disposed within a metal sleeve 18, which may be a ferrule, a connector or other metal fiber holding device, all generally referred to herein as a ferrule, wherein the outer end 22 of the ferrule 18 has been uniformly deformed radially inwardly to frictionally engage the outer surface 26 of the optical fiber 14. A device for performing the uniform deformation of the ferrule 18 is taught in U.S. Pat. No. 5,305,406, in which the end of the ferrule is impacted by a cone shaped impact device to uniformly deform the end 22 of the ferrule 18 inwardly to frictionally engage the outer surface 26 of the optical fiber 14.

As is discussed herebelow, a plurality of optical fibers may be bundled together within a ferrule, and the outer end of the ferrule can be uniformly deformed to frictionally engage the outer surfaces of the outer optical fibers with sufficient force to mechanically hold the bundled optical fibers together. As will be understood from the following detailed description, some configurations of particular numbers of optical fibers are well suited for impact mounting, whereas other configurations and numbers of optical fibers are not well suited for impact mounting.

FIGS. 2A and 2B depict a device 30 including the impact mounting of two optical fibers 34 and 38 within a ferrule 42. As is best seen in the front view of FIG. 2B, the two optical fibers 34 and 38 are pressed together by the impact mounting that frictionally contacts the outer surface 46 and 50 of each of the two optical fibers 34 and 38.

FIGS. 3A and 3B depict a device 60 including the impact mounting of three optical fibers 64, 68 and 72 within a ferrule 76. It is to be understood that each of the three optical fibers frictionally contacts the other by being pressed against the other fiber by the impact mounting, and that an outer side surface of each of the three optical fibers is in frictional contact with the deformed ferrule tip material.

FIGS. 4A and 4B depict a device 80 including the impact mounting of a four optical fibers 84, 88, 92 and 96 in a bundle within a ferrule 100. As depicted therein, an inner side surface portion of each of the four optical fibers is pressed against two of the other optical fibers, and an outer side surface portion of each of the four optical fibers is frictionally contacted by the deformed ferrule tip material.

FIG. 5 depicts a device 110 including the impact mounting of five optical fibers 114, 118, 122, 126, 130 in a bundle within a ferrule 134, wherein the bundle is configured with a central optical fiber 114 and four outwardly disposed optical fibers 118, 122, 126 and 130. An inner side surface of each of the four outwardly disposed optical fibers 118, 122, 126 and 130 is in frictional contact with the center fiber 114, and an outer side surface of each of the four outwardly disposed optical fibers is in frictional contact with the deformed ferrule tip material.

FIG. 6 depicts a device 140 including a six optical fiber bundle, wherein the bundle is configured with a central optical fiber 144 and five outwardly disposed optical fibers 148, 152, 156, 160 and 164. An inner side surface of each of the five outwardly disposed optical fibers 148, 152, 156, 160 and 164 is in frictional contact with the center fiber 144, and an outer side surface of each of the five outwardly disposed optical fibers is in frictional contact with the deformed ferrule tip material.

FIGS. 7A and 7B depict a device 170 including a seven optical fiber bundle that is impact mounted within a ferrule 174. As depicted therein, the seven optical fiber bundle includes a central optical fiber 178 and six symmetrically disposed outer optical fibers 182, 186, 190, 194, 198, 202. Inner side surface portions of each of the outer optical fibers 182, 186, 190, 194, 198 and 202 are in frictional contact with the central optical fiber 178 and with two adjacent outer optical fibers. An outer side surface of each of the six outward optical fibers is in frictional contact with the deformed ferrule tip material.

At this point certain desirable and undesirable characteristics of the impact mounted optical fiber bundles described and depicted hereabove can be discussed. Firstly, it is very desirable in the usage of bundled optical fibers in fiber optic devices that the optical fibers within a bundle be uniformly, fixedly positioned and that the positioning be accurately repeatable from device to device. As is next described, the five optical fiber bundle device 110 and six optical fiber bundle device 140 depicted and described hereabove are problematic, and are not as desirable as the two, three, four and seven optical fiber bundles depicted and described hereabove.

Particularly, the three, four and seven optical fiber bundles 60, 80 and 170 form compact, symmetrical groupings in which each of the optical fibers is firmly, fixedly held in place by frictional contact with at least two other optical fibers. In contrast, the five optical fiber bundle 110 depicted in FIG. 5 includes the four outer optical fibers 118, 122, 126 and 130 that are not firmly held in a particular place by contact with other optical fibers. Particularly, with reference to outer optical fiber 118 of FIG. 5, it can be seen that it is not held in place by frictional contact with other outer optical fibers 122, 126 or 130. Therefore, when the five optical fiber bundle 110 is assembled, prior to an impact mounting step utilizing a device such as is taught in U.S. Pat. No. 5,305,406, the orientation of the four outer optical fibers is not fixed. That is, the four outer optical fibers might be grouped loosely within the ferrule towards the bottom, rather than in a fixed, symmetrical pattern as depicted in FIG. 5. Indeed, the orientation of the five optical fibers within a ferrule prior to impact mounting is random, and not-repeatable in the manufacturing of a plurality of impact mounted five optical fiber bundle devices. As a result, the impact mounted five optical fiber bundle device 110 is suboptimum and not a desirable configuration.

The six optical fiber bundle device 140 depicted in FIG. 6 is also an undesired configuration for the same reasons as the five optical fiber bundle 110 described hereabove. Particularly, as depicted in FIG. 6, the five outer optical fibers 148, 152, 156, 160 and 164 are not held in place by frictional contact with each other, such that the location of the five outer optical fibers is not fixed, but rather is random, such that the manufacturing of impact mounted six optical fiber bundle devices is not accurately repeatable from device to device. Therefore, the six optical fiber bundle configuration 140 is disfavored, as is the five optical fiber bundle configuration 110 described above.

It can therefore be understood that the desirable features of the impact mounted optical fiber bundles depicted in FIGS. 2A, 3A, 4A and 7A are that the optical fibers are symmetrically disposed relative to the central axis of the optical fiber bundle, and that the individual optical fibers are firmly held in place by frictional contact with other optical fibers and with the deformed tip material of the impact mounted ferrule.

FIG. 8 is a front view of the tip portion of an impact mounted optical fiber bundle device 210 including 13 optical fibers within a ferrule 214. The 13 optical fiber bundle 210 can be thought of as being formed from an inner seven optical fiber bundle orientation 218 with six additional optical fibers 222, 226, 230, 234, 238 and 242 that are symmetrically disposed around the outer six optical fibers of the seven optical fiber bundle, such that each of the six outer optical fibers 222, 226, 230, 234, 238 and 242 has inner side surface portions that make frictional contact with two inner optical fibers, and wherein an outer side surface of each of the six outer optical fibers makes frictional contact with the inwardly deformed tip material of the impact mounted ferrule 214. It is to be understood that the 13 optical fiber bundle device 210 depicted in FIG. 8 is a symmetrical arrangement of optical fibers wherein each of the optical fibers is fixedly held by frictional contact with at least two other optical fibers; thus the 13 optical fiber bundle configuration 210 depicted in FIG. 8 is desirable in that the location of each of the optical fibers in the bundle is fixed and is therefore repeatable in manufacturing from device to device.

FIG. 9 is a front view depicting an impact mounted optical fiber bundle device 250 including 19 optical fibers within a ferrule 254. The 19 optical fiber bundle can be thought of as being formed from an inner thirteen optical fiber bundle orientation 258 (see FIG. 8) with six additional optical fibers 262, 266, 270, 274, 278 and 282 that are symmetrically disposed around the outer six optical fibers of the 13 optical fiber bundle 258, such that inner side surface portions of each of the six outer optical fibers 262, 266, 270, 274, 278 and 282 makes frictional contact with three inner optical fibers, and wherein an outer side surface of each of the six outer optical fibers 262, 266, 270, 274, 278 and 282 makes frictional contact with the inwardly deformed tip material of the impact mounted ferrule 254. It is to be understood that the 19 optical fiber bundle depicted in FIG. 9 is a symmetrical arrangement of optical fibers wherein each of the optical fibers is fixedly held by frictional contact with at least two other optical fibers, thus the 19 optical fiber bundle 250 depicted in FIG. 9 is desirable in that the location of each of the optical fibers in the bundle is fixed and is therefore repeatable in manufacturing from device to device.

It can now be understood that an impact mounted bundled optical fiber device of the present invention having more than four optical fibers, will include a central optical fiber having six optical fibers disposed outwardly therefrom, wherein the central axis of each of the six optical fibers will be located at the same radial distance from the central axis of the central optical fiber. An impact mounted bundled optical fiber device of the present invention having more than seven optical fibers will include a further six optical fibers being located outwardly from the inner seven optical fiber group described hereabove, wherein the additional six optical fibers will be symmetrically disposed relative to the inner seven optical fiber bundle, and wherein each of the six outward optical fibers will be disposed at the same radial distance from the central axis of the central optical fiber. Impact mounted bundled optical fiber devices having greater than 13 optical fibers will likewise include a particular number of optical fibers that are symmetrically disposed relative to the central optical fiber, and wherein the radial distance of each of the additional optical fibers will be located in groups having discrete radial distances from the central axis of the central optical fiber.

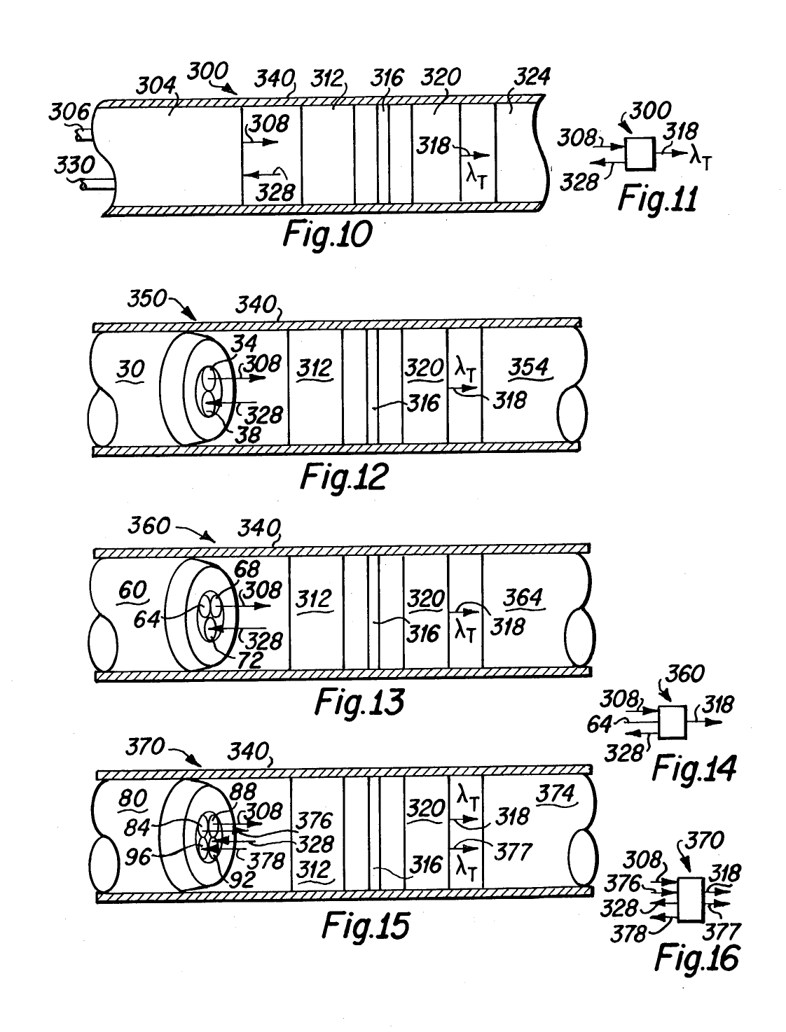

The impact mounted bundled optical fiber devices 30, 60, 80, 170, 210 and 250 described and depicted hereabove may be advantageously utilized in a variety of optical components, such as an add/drop device implementation. A prior art add/drop device 300 is depicted in FIGS. 10 and 11, wherein FIG. 10 depicts the basic components of an add/drop device, and FIG. 11 is a schematic representation thereof. As depicted in FIGS. 10 and 11, a two optical fiber pigtail 304 includes an input optical fiber 306 having an input signal 308 that is directed through a lens 312 to a filter 316. A particular transmitted signal 318 of wavelength λₜ, is passed through the filter 316 to a second lens 320 and to an output optical fiber 324 as a transmitted optical signal of a particular selected wavelength λₜ. The remaining wavelengths of the input optical signal 308 are reflected by the filter 316 back through the lens 312 as a reflected optical signal 328 to the reflected signal optical fiber 330. The pigtail 304, lenses 312 and 320, filter 316 and output optical fiber 324 are all held within a housing 340. This well known add/drop optical device is well understood by those skilled in the art.

An optical component, particularly an add/drop device component 350, utilizing a two fiber impact mounted device of the present invention is depicted in FIG. 12, and it includes the two fiber impact mounted device 30 described hereabove with respect to FIGS. 2A and 2B. It is to be noted that the add/drop device 350 may include identical internal components of the add/drop device 300 depicted in FIGS. 10 and 11 and described hereabove disposed within a housing 340. Specifically, the add/drop device 350 may include a first lens 312, a filter 316, a second lens 320, which together function such that an input optical signal 308 from an input fiber, such as optical fiber 34, and a reflected signal 328 which is output through the reflected signal optical fiber 38, as well as a transmitted wavelength λₜ signal 318. The output optical fiber device 354 of the add/drop device 350 may be a second impact mounted optical fiber device, such as device 30, or it may comprise a single optical fiber connector including the output optical fiber 324 of FIG. 10.

An optical component, particularly an add/drop device component 360, utilizing a three fiber impact mounted device of the present invention is depicted in FIGS. 13 and 14, and it includes the three fiber impact mounted device 60 described hereabove with respect to FIGS. 3A and 3B, and a schematic diagram of the device 360 is presented in FIG. 14. It is to be noted that the add/drop device 360 may include identical internal components of the add/drop device 300 depicted in FIGS. 10 and 11 and described hereabove disposed within a housing 340. Specifically, the add/drop device 360 may include a first lens 312, a filter 316, a second lens 320 which functions such that an input optical signal 308 from an input fiber, such as optical fiber 68, and a reflected signal 328 which is output through the reflected signal optical fiber 72, as well as a transmitted wavelength λₜ signal 318. The output optical fiber 364 of the add/drop device 360 may be a second impact mounted optical fiber device, such as device 60, or it may comprise another optical fiber device connector such as devices 30 or 324. It is to be noted that when the three optical fiber bundle device 60 is used in an add/drop device 360, that one of the optical fibers remains available for another use.

An optical component, particularly an add/drop device component 370, utilizing a four fiber impact mounted device of the present invention is depicted in FIGS. 15 and 16, and it includes the four fiber impact mounted device 80 described hereabove with respect to FIGS. 4A and 4B, and a schematic diagram of the device 320 is presented in FIG. 16. It is to be noted that the add/drop device 370 may include identical internal components of the add/drop device 300 depicted in FIGS. 10 and 11 and described hereabove disposed within a housing 340. Specifically, the add/drop device 370 may include a first lens 312, a filter 316, a second lens 320 which functions such that an input optical signal 308 from an input fiber, such as optical fiber 88, and a reflected signal 328 which is output through the reflected signal optical fiber 92, as well as a transmitted wavelength λₜ signal 318. The output optical fiber 374 of the add/drop device 350 may be a second impact mounted optical fiber device, such as device 80, or it may comprise another optical fiber device such as has been described hereinabove. A significant feature of the add/drop device 370 is that the remaining two optical fibers 84 and 96 may be utilized to function as a second add/drop component. Particularly, an input optical signal 376 may be input through optical fiber 84, through lens 312 to filter 316, whereupon a second transmitted signal 377 having the same wavelength λₜ as the first transmitted signal 318, is created. A second reflected optical signal 378 is output through the second reflected signal optical fiber 96. Therefore, the impact mounted four optical fiber bundle may function as two add/drop devices within a single housing.

An optical component, particularly an add/drop device component 380, utilizing a seven fiber impact mounted device of the present invention is depicted in FIGS. 17 and 18, and it includes the seven fiber impact mounted device 170 described hereabove with respect to FIGS. 7A and 7B, and a schematic diagram of the device 380 is presented in FIG. 18. It is to be noted that the add/drop device 380 may include identical internal components of the add/drop device 300 depicted in FIGS. 10 and 11 and described hereabove disposed within a housing 340. Specifically, the add/drop device 380 may include a first lens 312, a filter 316, a second lens 320 which functions such that an input optical signal 308 from an input fiber, such as optical fiber 202, and a reflected signal 328 which is output through the reflected signal optical fiber 190, as well as a transmitted wavelength λₜ signal 318. The output optical fiber 384 of the add/drop device 380 may be a second impact mounted optical fiber device, such as device 170, or it may comprise another optical fiber device such as has been described hereinabove. The impact mounted seven optical fiber bundle device 170 can function as three add/drop components where various pairs of the optical fibers in the bundle can act as input signal and output reflected signal pairs. In this configuration, and as is shown in FIG. 18, the seven optical fiber bundle can act as three pairs of input and reflected signal output fibers, and three transmitted signals, each having wavelength λₜ, are transmitted from the device 380.

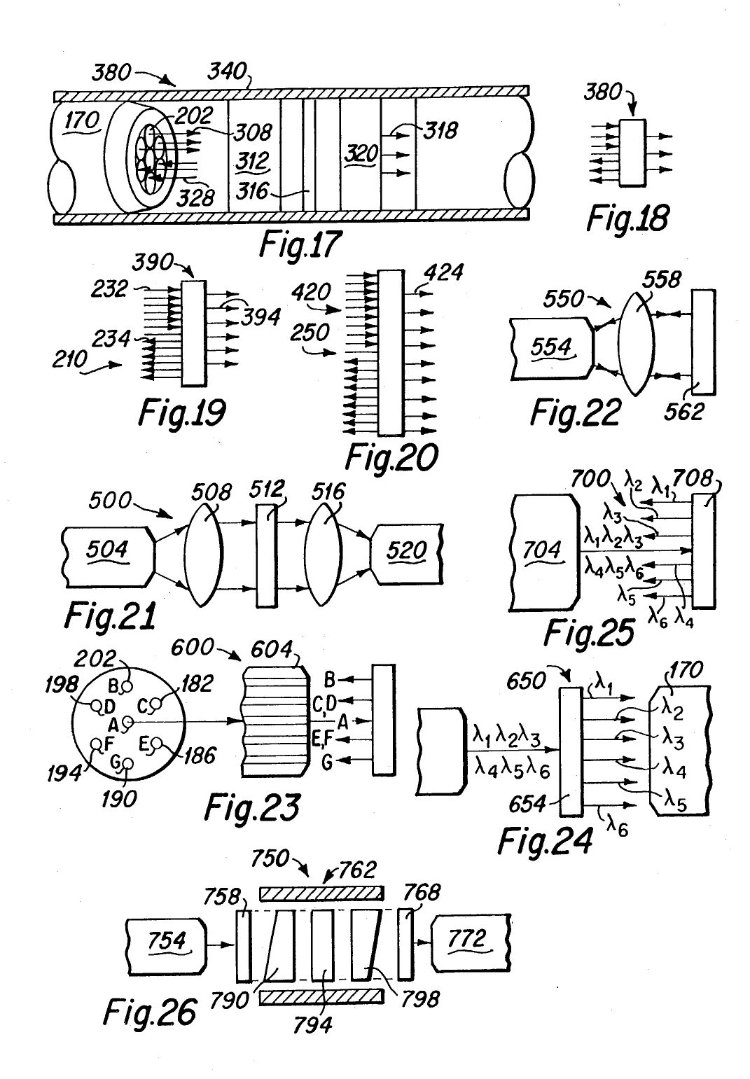

An optical component, specifically an add/drop device 390, that utilizes an impact mounted thirteen optical fiber device 210 of the present invention is schematically depicted in FIG. 19. As is depicted therein, and will be understood from the preceding depictions and descriptions of other bundled optical fiber devices of the present invention, the impact mounted thirteen optical fiber device of the present invention may be configured to act as six separate add/drop devices each having an input optical fiber such as optical fiber 232 and a reflected optical fiber such as optical fiber 234, and wherein six discrete transmitted optical signals 394, each passing through the filter 316, and each having the transmitted wavelength λₜ, are transmitted. The six transmitted signals 394 may be received by a second impact mounted thirteen optical fiber device, or any other optical fiber device that is capable of being properly aligned to receive the six transmitted optical signals.

An optical component, specifically an add/drop device 420, that utilizes an impact mounted nineteen optical fiber device 250 of the present invention is schematically depicted in FIG. 20. As is depicted therein, and will be understood from the preceding depictions and descriptions of other bundled optical fiber devices of the present invention, the impact mounted nineteen optical fiber device 250 of the present invention may be configured to act as nine separate add/drop devices each having an input optical fiber, such as optical fiber 282, and a reflected optical fiber, such as optical fiber 270, and wherein nine discrete transmitted optical signals 424, each passing through the filter 316, and each having the transmitted wavelength λₜ, are transmitted. The nine transmitted signals 424 may be received by a second impact mounted nineteen optical fiber device, or any other optical fiber device that is capable of being properly aligned to receive the nine transmitted optical signals.

From the preceding description, it will be clear to those skilled in the art that the impact mounted bundled optical fiber devices 30, 60, 100, 170, 210 and 250, can be utilized in virtually any application that benefits from an ordered, symmetric, repeatably manufactured optical fiber device. Additionally, while the impact mounted bundled optical fiber devices of the present invention have been shown to include a device having nineteen optical fibers, it is to be understood, and will be understood by those skilled in the art, that impact mounted bundles of optical fibers can be created having more than nineteen optical fibers, wherein each optical fiber is fixedly and symmetrically oriented, and fixedly held in place by an impact mounted ferrule, as has been described hereinabove. By way of example, FIG. 21 depicts a generalized architecture 500 utilizing the impact mounted optical fiber bundle of the present invention.

As depicted in FIG. 21, light energy from an input ferrule 504 is passed through a beam expansion and collimation device 508 to an optical processing element 512, and thereafter to a beam contracting and focusing device 516 and then to a receiving ferrule 520. In this device 500, either the input ferrule 504 or the receiving ferrule 520 or both of the input ferrule and receiving ferrule is/are an impact mounted optical fiber bundle of the present invention, such as devices 30, 60, 100, 170, 210 and 250. The processing element 512 as generally depicted in FIG. 21 can be virtually any type of optical signal processing device that is now known or many that will be developed in the future. For instance, as has been depicted and described hereabove, if the processing element 512 is a filter then the device depicted in FIG. 21 can act as the add/drop device that has been described with regard to FIGS. 12-20. The processing element 512 might also consist of other types of devices including a waveguide hologram, an optical beam bifurcation or combination device, a wavelength shifting device, a multiplexer or demultiplexer device, an isolator device, or other such devices as are known to those skilled in the art or will become known.

FIG. 22 depicts a second basic architecture 550 of the present invention including an optical signal input device 554 which comprises an impact mounted bundled optical fiber device of the present invention, a beam expansion and collimation device 558 and a processing element 562 which acts as a reflecting beam processing element. As can be seen in FIG. 21, the optical signal from the impact mounted bundled optical fiber device 554 is passed through the beam expansion and collimation device 558 to the processing element 562, and reflected back from the processing element through the beam expansion and collimation device 558 which now acts as a beam contraction and focusing device 554, and then back to the impact mounted bundled optical fiber device. The input optical signal may be carried on one or more of the bundled optical fibers of the input device, and the reflected signal is output into one or more of the other optical fibers of the impact mounted bundled optical fiber device. The processing element may include various types of processing elements described hereabove.

By way of a particular example, FIG. 23 is a schematic diagram depicting an optical signal bifurcation device and/or combination device 600. As depicted therein, an impact mounted bundled optical fiber device 604 having seven optical fibers, such as device 170, is utilized. An input signal A is input through the central optical fiber 178 to the processing element 608 which in this case is a reflecting holographic bifurcation device. Six optical signals (B, C, D, E, F and G) are reflected back from the holographic bifurcation device to individual ones of the outer optical fibers 202, 182, 198, 186, 194 and 190, respectively, of the impact mounted bundled optical fiber device 170. It is therefore to be understood that the input signal A has been divided into six output signals B, C, D, E, F and G, where each signal is output to a different optical fiber in the seven optical fiber impact mounted bundle 170. As will be understood by those skilled in the art, the holographic bifurcation device 608 depicted in FIG. 23 can also be utilized as a signal combining device by reversing the direction of the optical signals. That is, six different optical signals can be input from the six outer optical fibers towards the holographic element and combined to form an output signal that is output to the central optical fiber 178 of the impact mounted optical fiber bundle 170. As will be understood by those skilled in the art, although the device depicted in FIG. 23 is shown utilizing the impact mounted bundled seven optical fiber device 170, that bifurcation and/or combination devices of the present invention can include the three, four, seven, thirteen and nineteen impact mounted bundled optical fiber devices of the present invention.

FIG. 24 depicts a transmitting multiplexer/demultiplexer device 650 of the present invention. As depicted therein, an input optical signal includes a plurality of wavelengths (λ1, λ2, λ3, λ4, λ5 and λ6) that is input to processing element 654 including a transmitting demultiplexer optical element. The processing element 654 separates the input signal into its various wavelengths and outputs the signal at locations that correspond to the positions of the six outer optical fibers of a impact mounted bundled seven optical fiber device 170 of the present invention. It is therefore to be understood that the device depicted in FIG. 24 can be utilized to separate out particular wavelengths of optical signals from the input signal, and that the device can be operated in the opposite direction to combine six input signals from the outer optical fibers of an impact mounted bundled optical fiber device 170 to produce a single output signal that combines the six wavelengths that are transmitted through the processing element. As has been indicated hereabove, a device of the present invention can be fabricated using impact mounted optical fiber bundles having three, four, seven, thirteen and nineteen optical fibers.

FIG. 25 is a schematic depiction of yet another particular architecture 700 of the present invention that comprises a reflecting multiplexer/demultiplexer device. In this device an impact mounted bundled optical fiber device 704, such as the seven optical fiber device 170 is utilized. An optical signal including wavelengths λ1, λ2, λ3, λ4, λ5 and λ6, is input in the central optical fiber 178 to the reflecting processing element 708. Optical signals from the processing element 708 having wavelengths λ1, λ2, λ3, λ4, λ5 and λ6 are reflected back from the processing element at locations that correspond to locations the six outer optical fibers, 202, 182, 198, 186, 194 and 190 respectively. In this device, the input signal is demultiplexed into the six output signals of the particular wavelengths λ1-λ6. It will be obvious to those skilled in the art that the optical signal path of this invention can be reversed, whereupon the device depicted in FIG. 24 acts as a multiplexer in combining input signals from the six outer optical fibers into an output signal having wavelengths λ1-λ6, that is output through the central optical fiber 178 of the impact mounted bundled seven optical fiber device 170 of the present invention. As has been indicated hereabove with regard to other devices, this embodiment of the present invention includes the use of impact mounted bundled optical fiber devices having three, four, seven, thirteen and nineteen optical fibers.

FIG. 26 depicts still another specific embodiment of the present invention that comprises an isolator device 750. As depicted therein, an impact mounted bundled optical fiber device 754 of the present invention provides input optical signals through a GRIN lens 758 to an isolator core processing element 762. Optical signals from the isolator core are then directed through a second GRIN lens 768 to a receiving impact mounted bundled optical fiber device 772. As is well known to those skilled in the art, the isolator core 762 may include a magnet 786 that surrounds a first birefringent crystal 790, a Faraday rotator 794 and a second birefringent crystal 798. The isolator device 750 of the present invention depicted in FIG. 26 can be formed utilizing the impact mounted bundled optical fiber devices of the present invention having two, three, four, seven, thirteen and nineteen optical fibers, as will be understood by those skilled in the art.

While the present invention has been shown and described with regard to certain preferred embodiments, it is to be understood that those skilled in the art will no doubt develop other and further alterations and modifications related thereto. It is therefore intended that the following claims cover all such alterations and modifications that nevertheless include the true spirit and scope of the present invention.

What is claimed is:

1. A bundled optical fiber device, comprising:
a plurality of optical fibers;
a metal ferrule being disposed around said plurality of optical fibers, said ferrule being generally cylindrical and having a central bore formed axially therethrough and having a central axis thereof, and wherein said plurality of optical fibers are disposed within said bore of said ferrule;
wherein a tip portion of said ferrule is symmetrically inwardly deformed to make frictional contact with an outer surface of two or more of said optical fibers;
said optical fibers being symmetrically disposed around said central axis of said bore, and wherein each of said optical fibers is held fixedly in a location by frictional contact with at least one other optical fibers within said optical fiber bundle.

2. A device as described in claim 1, wherein the number of optical fibers within said bundle is a number selected from the group consisting of two, three, four, seven, 13 and 19.

3. A device as described in claim 1 including three optical fibers, wherein inner side surface portions of each of said three optical fibers make frictional contact with two of said optical fibers.

4. A device as described in claim 1 including four optical fibers, wherein inner side surface portions of each of said optical fibers makes frictional contact with two of said optical fibers.

5. A device as described in claim 1 including seven optical fibers, wherein a central one said optical fiber is disposed coaxially with said central bore, and wherein an outer six of said optical fibers are disposed around said central optical fiber, and wherein inner side surface portions of each of said six optical fibers make frictional contact with three said optical fibers.

6. A device as described in claim 1 including thirteen optical fibers, wherein one said optical fiber is disposed coaxially with said central bore, an inner six said optical fibers are disposed around said central optical fiber, and wherein an outer six further optical fibers are disposed symmetrically around said inner six optical fibers.

7. A device as described in claim 5 wherein said outer six optical fibers are disposed at the same radial distance from the central axis of said central bore.

8. An optical device, comprising:
a housing for holding a bundled optical fiber device and an optical processing element, wherein said bundled optical fiber device includes:
a plurality of optical fibers;
a metal ferrule being disposed around said plurality of optical fibers, said ferrule being generally cylindrical and having a central bore formed axially therethrough and having a central axis thereof, and wherein said plurality of optical fibers are disposed within said bore of said ferrule;
wherein a tip portion of said ferrule is symmetrically inwardly deformed to make frictional contact with an outer surface of two or more of said optical fibers;
said optical fibers being symmetrically disposed around said central axis of said bore, and wherein each of said optical fibers is held fixedly in a location by frictional contact with at least one other optical fibers within said optical fiber bundle.

9. A device as described in claim 8, wherein the number of optical fibers within said bundle is a number selected from the group consisting of two, three, four, seven, 13 and 19.

10. A device as described in claim 8 wherein said optical processing element includes an optical filter.

11. An optical device as described in claim 10, wherein said impact mounted optical fiber bundle includes two optical fibers.

12. An optical device as described in claim 10, wherein said impact mounted optical fiber bundle includes three optical fibers, wherein inner side surface portions of each of said three optical fibers make frictional contact with two of said optical fibers.

13. An optical device as described in claim 10, wherein said impact mounted optical fiber bundle includes four optical fibers, wherein inner side surface portions of each of said optical fibers make frictional contact with two of said optical fibers.

14. An optical device as described in claim 10, wherein said impact mounted optical fiber bundle includes seven optical fibers, wherein a central one said optical fiber is disposed coaxially with said central bore, and wherein an outer six of said optical fibers are disposed around said central optical fiber, and wherein inner side surface portions of each of said six optical fibers make frictional contact with three said optical fibers.

15. An optical device as described in claim 10, wherein said impact mounted optical fiber bundle includes thirteen optical fibers, wherein one said optical fiber is disposed coaxially with said central bore, an inner six said optical fibers are disposed around said central optical fiber, and wherein an outer six further optical fibers are disposed symmetrically around said inner six optical fibers.

16. An optical device as described in claim 8 wherein said impact mounted optical fiber bundle includes 19 optical fibers

17. An optical device as described in claim 8, wherein two bundled optical fiber devices are disposed within said housing.

18. An optical device as described in claim 8 wherein said optical processing element includes an optical signal bifurcation device.

19. An optical signal combining device as described in claim 8 wherein said optical processing element includes an optical signal combining device.

20. An optical signal multiplexing device as described in claim 8 wherein said optical processing element includes an optical signal multiplexing device.

21. An optical signal demultiplexing device as described in claim 8 wherein said optical processing element includes an optical signal demultiplexing device.

22. An optical signal isolator device as described in claim 8 wherein said optical processing element includes an optical signal isolator core device.
